(19) United States
(12) Patent Application Publication
(10) Pub. No.: US 2022/0103020 A1
(43) Pub. Date: Mar. 31, 2022

(54) WIRELESS CHARGING SYSTEM FOR REMOVING FOREIGN OBJECT AND FOREIGN OBJECT REMOVING METHOD OF WIRELESS CHARGING SYSTEM

(71) Applicant: ELECTRONICS AND TELECOMMUNICATIONS RESEARCH INSTITUTE, Daejeon (KR)

(72) Inventors: Jung Ick MOON, Daejeon (KR); Sang-Won KIM, Daejeon (KR); Seong-Min KIM, Daejeon (KR); In Kui CHO, Daejeon (KR)

(21) Appl. No.: 17/468,866

(22) Filed: Sep. 8, 2021

(30) Foreign Application Priority Data
Sep. 29, 2020 (KR) 10-2020-0127258

(51) Int. Cl. H02J 50/60; H02J 50/12; H02J 50/90; H02J 50/00

(52) U.S. Cl. CPC H02J 50/60; H02J 50/005; H02J 50/90; H02J 50/12

(57) ABSTRACT

Provided are a wireless charging system for removing a foreign object and a foreign object removing method of the wireless charging system that may detect whether a foreign object is attached using a sensor of the wireless charging system to automatically and quickly remove the foreign object.

### CROSS-REFERENCE TO RELATED APPLICATION

This application claims the benefit of Korean Patent Application No. 10-2020-0127258 filed on Sep. 29, 2020, in the Korean Intellectual Property Office, the entire disclosure of which is incorporated herein by reference for all purposes.

### BACKGROUND

### 1. Field of the Invention

One or more example embodiments relate to a wireless charging system and a foreign object removing method of the wireless charging system, and more particularly, to an apparatus and method for detecting a foreign object attached onto a surface of a transmitter for wireless charging, and removing the detected foreign object.

### 2. Description of Related Art

With expansion of an application field of wireless charging technology to fields of tens of watts (W) or greater, if a metallic foreign object is attached to a corresponding system, strong induced current is generated on a metal surface due to a high output magnetic field, and heat is rapidly generated due to unique resistivity of a metal, which leads to accidents such as fire.

In other words, a general wireless charging system using a magnetic field includes a transmission coil, a reception coil, and a coil cover. If an output of the transmission coil is high, a magnetic field transmitted to the reception coil as well as the transmission coil has a significant strength. Accordingly, if a metallic foreign object is unintentionally attached to the coil cover, an accident may occur during charging.

In addition, if a metallic foreign object is attached to the wireless charging system, it is very difficult to detect a small metallic foreign object at intermediate power or higher even though it is possible to electrically detect the metallic foreign object at low power.

Thus, there is a need for a method to safely perform wireless charging while more effectively and quickly removing a foreign object if the foreign object is attached to a coil or a cover of a wireless charging system.

### SUMMARY

One or more example embodiments provide a method of detecting a foreign object attached to a transmission coil or a reception coil in a wireless charging system to more effectively remove the detected foreign object.

One or more example embodiments provide a method of rapidly, mechanically removing a foreign object attached to a transmission coil or a reception coil based on a characteristic that it becomes difficult to detect a foreign object as an output strength of a magnetic field generated in a wireless charging system increases.

According to an aspect, there is provided a transmitter for wireless charging including a transmission coil, a cover configured to protect a surface of the transmission coil, a foreign object removal screen disposed on a surface of the cover to remove a foreign object, and rotating bodies connected to the foreign object removal screen and disposed at both ends of the cover.

The foreign object removal screen may be disposed in a charging area of the transmitter for wireless charging that includes the transmission coil, and may be configured to detect a foreign object to be removed among objects detected in the charging area.

The rotating bodies may be configured to perform a rotational motion to continuously move a foreign object detected in a charging area of the foreign object removal screen.

The foreign object removal screen may enclose an upper surface and a lower end of the cover that protects the surface of the transmission coil, and may move according to the rotational motion of the rotating bodies.

The foreign object may be pushed from a first position sensed by the foreign object removal screen to a second position according to a vertical movement or a horizontal movement of the foreign object removal screen.

When the foreign object removal screen reaches one end of both ends in which the rotating bodies are disposed, the foreign object may fall to an outer region of the one end.

When the foreign object removal screen reaches one end of both ends in which the rotating bodies are disposed, the foreign object may fall to a movement preventer disposed at the one end.

According to another aspect, there is provided a transmitter for wireless charging including a transmission coil, a cover configured to protect a surface of the transmission coil, a foreign object removal wiper disposed on a surface of the cover to remove a foreign object, and a rotating body configured to control rotation of the foreign object removal wiper.

The foreign object removal wiper may be disposed at one end of the cover to detect a foreign object to be removed among objects detected in a charging area of the transmitter for wireless charging that includes the transmission coil.

When a foreign object is detected in the charging area, the rotating body may perform a rotational motion such that the foreign object removal wiper may move at a predetermined angle in a specific direction.

The foreign object removal wiper may include a pressure sensor on one surface of the foreign object removal wiper, and the pressure sensor may be configured to determine a presence or absence of a foreign object attached to the surface while moving on a surface of the cover.

The foreign object may be removed while being pushed from a first position sensed by the foreign object removal wiper to a second position in a specific direction of the foreign object removal wiper.

According to another aspect, there is provided a transmitter for wireless charging including a transmission coil, a cover configured to protect a surface of the transmission coil, and a rotating body configured to allow the cover to rotate to remove a foreign object attached to a surface of the cover.

The rotating body may be shaped to penetrate a central region of the cover and the transmission coil, and may be configured to allow the cover to rotate at a constant speed along a central axis.

In the rotating body, a movement preventer may be fixed to an end of the rotating body, and the movement preventer may be spaced apart from the cover by a predetermined height. The foreign object may be caught by the movement preventer while being rotated by the rotating body, to fall to an outside of the cover.

According to another aspect, there is provided a foreign object removing method that is performed by a transmitter for wireless charging and that includes detecting an object present in a charging area of the transmitter, determining a voltage, a current, an impedance or a resonant frequency generated during the wireless charging when the object is detected, determining whether a foreign object is present among objects based on a band of the voltage, the current, the impedance or the resonant frequency, and removing a foreign object attached to the charging area of the transmitter by stopping the wireless charging when the foreign object is present.

The removing of the foreign object may include removing the foreign object attached to the charging area of the transmitter using a foreign object removal screen included in the transmitter, and the foreign object removal screen may be vertically or horizontally moved by a rotating body to continuously move the foreign object in one direction to induce the foreign object to fall.

The removing of the foreign object may include removing the foreign object attached to the charging area of the transmitter using a foreign object removal wiper included in the transmitter, and the foreign object removal wiper may be moved at a predetermined angle in a specific direction by a rotating body to induce the foreign object to fall.

The removing of the foreign object may include removing the foreign object attached to the charging area of the transmitter using a rotating body included in the transmitter, and the rotating body may induce the foreign object to fall while rotating at a constant speed along a central axis of the transmitter.

According to another aspect, there is provided a foreign object removing method that is performed by a transmitter for wireless charging and that includes analyzing an image including a charging area of the transmitter collected from an imaging device to determine whether a foreign object is present in the image, generating a sensing signal for removing the foreign object when the foreign object is present in the image, and removing a foreign object attached to the charging area of the transmitter using a foreign object remover coupled to the transmitter according to the sensing signal.

Additional aspects of example embodiments will be set forth in part in the description which follows and, in part, will be apparent from the description, or may be learned by practice of the disclosure.

According to example embodiments, a foreign object removing method may automatically and quickly remove a foreign object by detecting whether the foreign object is attached using a sensor of a wireless charging system.

According to example embodiments, a foreign object removing method may rapidly, mechanically remove a foreign object attached to a transmission coil or a reception coil based on a characteristic that it becomes difficult to detect a foreign object as an output strength of a magnetic field generated in a wireless charging system increases.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a wireless charging system according to an example embodiment;

FIGS. 2A and 2B are diagrams illustrating a structure of a wireless charging system for removing a foreign object using a foreign object removal screen according to an example embodiment;

FIGS. 3A and 3B are diagrams illustrating operations of a foreign object removal screen according to an example embodiment;

FIGS. 4A to 4D are diagrams illustrating an example in which a foreign object falls through a foreign object removal screen according to an example embodiment;

FIGS. 5A and 5B are diagrams illustrating a structure of a wireless charging system for removing a foreign object using a foreign object removal wiper according to an example embodiment;

FIGS. 6A and 6B are diagrams illustrating a structure of a wireless charging system for removing a foreign object using a rotating body according to an example embodiment;

FIG. 7 is a diagram illustrating a structure of a wireless charging system for removing a foreign object using an inclined cover according to an example embodiment;

FIG. 8 is a flowchart illustrating a wireless charging process for removing a foreign object according to an example embodiment; and

FIG. 9 is a flowchart illustrating a foreign object removing method according to an example embodiment.

### DETAILED DESCRIPTION

Hereinafter, example embodiments will be described in detail with reference to the accompanying drawings.

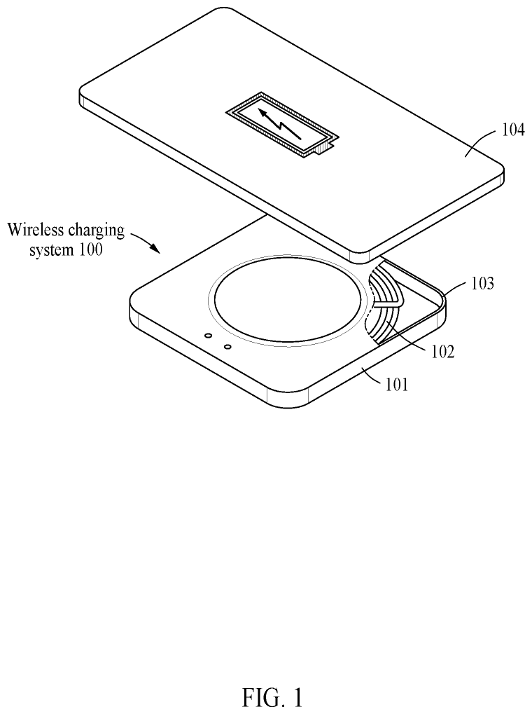

FIG. 1 is a diagram illustrating a wireless charging system according to an example embodiment.

Referring to FIG. 1, a wireless charging system may include a transmitter 101 and a receiver 104. The transmitter 101 may perform wireless charging by wirelessly transmitting and receiving power. For example, a foreign object remover may be attached to the transmitter 101, and the transmitter 101 may remove a foreign object attached to a surface using the foreign object remover. For example, the transmitter 101 may be configured in the form of a pad, a cradle, an access point (AP), a small base station or a stand, and may be of a ceiling-mounted type or a wall-mounted type.

The transmitter 101 may generate a magnetic field in a transmission coil 102, and various wireless power transmission standards based on an electromagnetic induction scheme of performing charging based on an electromagnetic induction principle in which electricity is induced in a reception coil due to an influence of the magnetic field. In an example, the transmitter 101 may perform wireless charging using a standard technology of an electromagnetic induction method according to a wireless charging technology standard organization.

The receiver 104 may include at least one wireless power receiving units, and may receive power from at least one transmitter 101. For example, the receiver 104 may be a small electronic device, and may include a mobile phone, a smartphone, a laptop computer, a digital broadcasting terminal, a personal digital assistant (PDA), and the like. The receiver 104 may be, for example, a device capable of charging a battery.

While performing wireless charging with the receiver 104, the transmitter 101 may remove a foreign object attached to a charging area of the transmitter 101, when a foreign object is present in the charging area of the transmitter 101. The transmitter 101 may detect a foreign object attached to the transmitter 101 before the foreign object remover is operated. A method of detecting a foreign object may be largely classified into an electrical method and a non-electrical method.

For example, in the electrical method, when a metal object having an influence on a power transmission is attached to a transceiver, an impedance, a voltage, a current or a resonant frequency allowed in a transceiver circuit may deviate from an allowable range for wireless charging, and accordingly an abnormal situation may be detected. However, in the case of using the electrical method to detect a foreign object, when an output is high and a metal object is small, an electrical detection may be difficult because an influence of the metal object is within the allowable range, even though it may be possible to detect a foreign object in response to a relatively low output. In addition, a non-metal object may be hardly detected.

In addition, the non-electrical method may be a method of detecting a foreign object using an image. In the non-electrical method, a foreign object may be detected by acquiring an image using a camera in a transmission and reception system and applying deep learning or various image processing algorithms. For example, in the non-electrical method, an outline for a charging area of a transmitter included in the image may be set using an image processing algorithm, and at least one region of interest (ROI) including a foreign object may be extracted based on pixel information and coordinate information of the image based on the outline. Subsequently, whether a foreign object is present in the image according to the ROI may be determined. Here, according to an example embodiment, whether a foreign object is attached to a transceiver or interposed between transceivers, based on coordinate information of the ROI.

In the case of using the non-electrical method to detect a foreign object, a cost may be added compared to the case of using the electrical method, and it may be sensitive to an external environment (for example, a lighting, and the like). However, it may be possible to detect a non-metal object as well as a metal object, and also possible to detect a small object according to a resolution.

Subsequently, the transmitter 101 may stop a generation of a magnetic field through the transmission coil 102 for wireless charging, and may remove the foreign object attached to the charging area of the transmitter 101 using the foreign object remover coupled to the transmitter 101.

For example, the transmitter 101 may detect an object present in the charging area of the transmitter 101. The transmitter 101 may detect a change in a current or a voltage of the transmission coil 102 to determine whether an object is present in the charging area of the transmitter 101. When an object is detected, the transmitter 101 may determine a voltage, a current, an impedance or a resonant frequency generated during wireless charging. To determine whether an object present in the charging area is a receiver for wireless charging or a foreign object, the transmitter 101 may determine a voltage, a current, an impedance or a resonant frequency. In other words, the transmitter 101 may determine a voltage, a current, an impedance or a resonant frequency for generating a magnetic field in the transmission coil 102 according to a resonance induction or a magnetic resonance.

The transmitter 101 may determine whether a foreign object is present among objects based on a band of the voltage, the current, the impedance or the resonant frequency. The transmitter 101 may detect that an overcurrent flows by a foreign object among the objects in the charging area according to the voltage, the current, the impedance or the resonant frequency. In other words, the transmitter 101 may determine a voltage, a current, an impedance or a resonant frequency having a band of a normal range for wireless charging, and determine a voltage, a current, an impedance or a resonant frequency having a band of a dangerous range due to a foreign object.

In an example, when the voltage, the current, the impedance or the resonant frequency having the band in the normal range is greater than or equal to a preset threshold, the transmitter 101 may determine that the object present in the charging area is a transmitter, based on the voltage, the current, the impedance or the resonant frequency. Based on the above determination result, the transmitter 101 may start wireless charging with an object determined as a receiver, or may maintain an operation of wireless charging.

In another example, when the voltage, the current, the impedance or the resonant frequency having the band in the dangerous range is less than or equal to the preset threshold, the transmitter 101 may determine that the object present in the charging area is a foreign object, based on the voltage, the current, the impedance or the resonant frequency.

In addition, it may be possible to detect whether a foreign object is attached to the transceiver or disposed between transceivers, by acquiring an image using a camera in a transmission and reception system and by applying deep learning or various image processing algorithms.

If the foreign object is present, the transmitter 101 may remove the foreign object attached to the charging area of the transmitter 101. For example, the transmitter 101 may stop a generation of a magnetic field through the transmission coil 102 for wireless charging, and may remove the foreign object attached to the charging area of the transmitter 101 using the foreign object remover coupled to the transmitter 101. The foreign object remover may include one of \textcircled{1} a foreign object removal screen, \textcircled{2} a foreign object removal wiper, and \textcircled{3} a rotating body, and the transmitter 101 may mechanically remove the foreign object attached to the charging area using one of the above-described foreign object removers.

\textcircled{1} Foreign Object Removal Screen

The transmitter 101 may use a foreign object removal screen included in the transmitter 101 to remove the foreign object attached to the charging area of the transmitter 101. Here, the foreign object removal screen may be vertically or horizontally moved by the rotating body to continuously move the foreign object in one direction to induce the foreign object to fall from a surface of the transmitter 101.

\textcircled{2} Foreign Object Removal Wiper

The transmitter 101 may use a foreign object removal wiper included in the transmitter 101 to remove the foreign object attached to the charging area of the transmitter 101. Here, the foreign object removal wiper may be moved at a predetermined angle in a specific direction by the rotating body to induce the foreign object to fall from the surface of the transmitter 101.

\textcircled{3} Rotating Body

The transmitter 101 may use a rotating body included in the transmitter 101 to remove the foreign object attached to the charging area of the transmitter 101. Here, the rotating body may induce the foreign object to fall from the surface of the transmitter 101, while rotating at a constant speed along a central axis of the transmitter 101.

When an electric signal such as a resonant frequency, a voltage, or a current outside the normal range is detected, or when a foreign object is detected using image information, and the like, the transmitter 101 or the receiver may stop wireless charging and remove the foreign object attached to the charging area of the transmitter 101.

Thus, it may be possible to efficiently remove a foreign object using the foreign object remover through a mechanical scheme when the foreign object is attached to the transmission coil 102 or the reception coil in the wireless charging system 100.

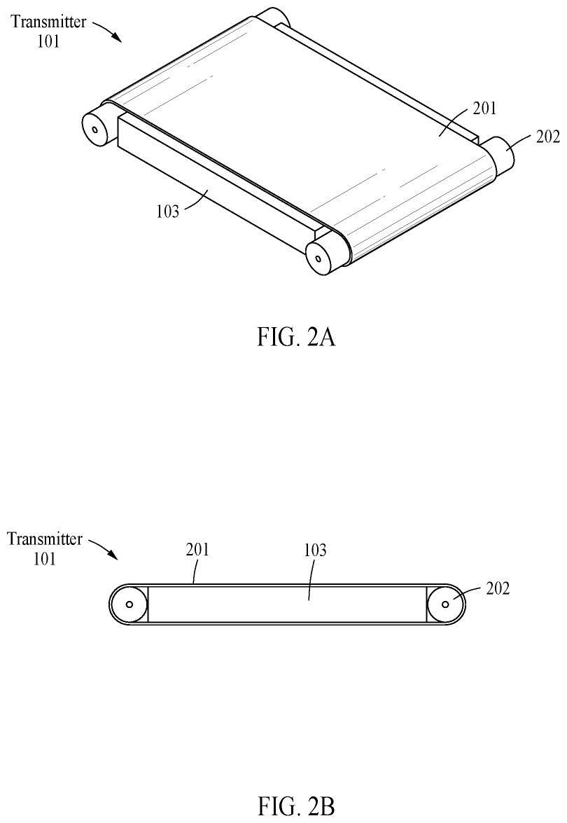

FIGS. 2A and 2B are diagrams illustrating a structure of a wireless charging system for removing a foreign object using a foreign object removal screen according to an example embodiment.

Referring to FIGS. 2A and 2B, a foreign object attached to a surface of a foreign object removal screen 201 may be removed using a foreign object removal screen 201. To this end, a transmitter 101 according to an example embodiment may include a transmission coil 102, a cover 103, the foreign object removal screen 201, and a rotating body 202. Since wireless charging using a magnetic field is performed sensitively to a metal and insensitively to a nonmetal (for example, a dielectric), all the above-described components of the transmitter may need to be formed of nonmetals.

Referring to FIG. 2A, to mechanically remove a foreign object, the foreign object removal screen 201 may be attached onto the cover 103. To protect a surface of the transmission coil, the cover 103 may be implemented to cover an outer surface of the transmission coil, that is, the outside. The foreign object removal screen 201 may be disposed in a charging area of the transmitter for wireless charging including the transmission coil, and may remove an object to be removed in connection with the wireless charging system.

The rotating body 202 may perform a rotational motion to continuously move a foreign object detected in the charging area on the foreign object removal screen 201. The foreign object removal screen 201 may enclose an upper surface and a lower end of the cover 103 that protects the surface of the transmission coil, as shown in FIG. 2B, and may be moved according to the rotational motion of the rotating body 202.

As a result, the foreign object removal screen 201 may be connected to the rotating body 202 that holds the foreign object removal screen 201 and that helps rotation while moving vertically or horizontally depending on an installation environment of the wireless charging system. In this example, the foreign object removal screen 201 may be moved all the time, or may operate only when a foreign object is detected in connection with the wireless system.

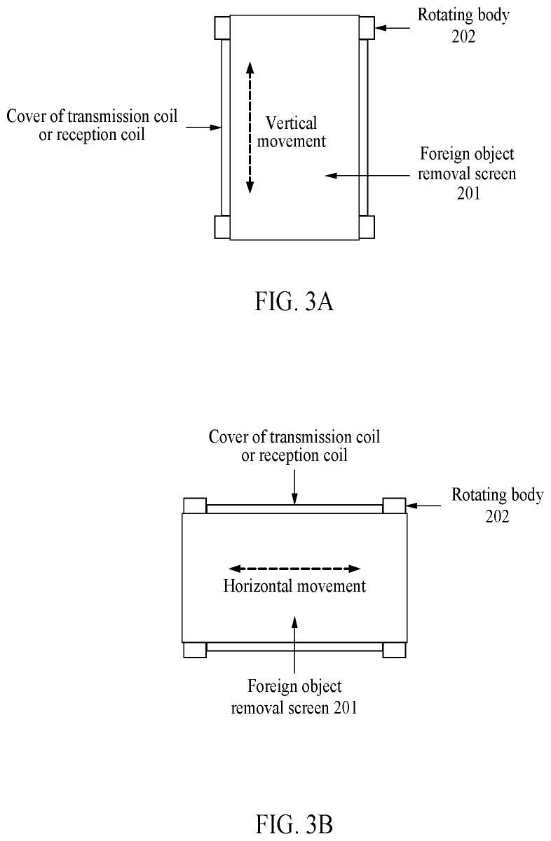

FIGS. 3A and 3B are diagrams illustrating operations of a foreign object removal screen according to an example embodiment.

Referring to FIGS. 3A and 3B, the foreign object removal screen 201 may be vertically or horizontally moved by rotating bodies 202. The rotating bodies 202 may vertically or horizontally rotate according to positions of the rotating bodies 202 disposed in a transmitter.

The rotating bodies 202 may be disposed on an upper side and a lower side of a cover as shown in FIG. 3A, and may be disposed on a left side and a right side, as shown in FIG. 3B. In addition, the rotating bodies 202 may be rotated in the same direction to change a position of the foreign object removal screen 201.

When a foreign object attached onto the foreign object removal screen 201 reaches both ends according to a movement of the foreign object removal screen 201, the foreign object may fall by gravity or may be caught in a movement preventer, to be removed.

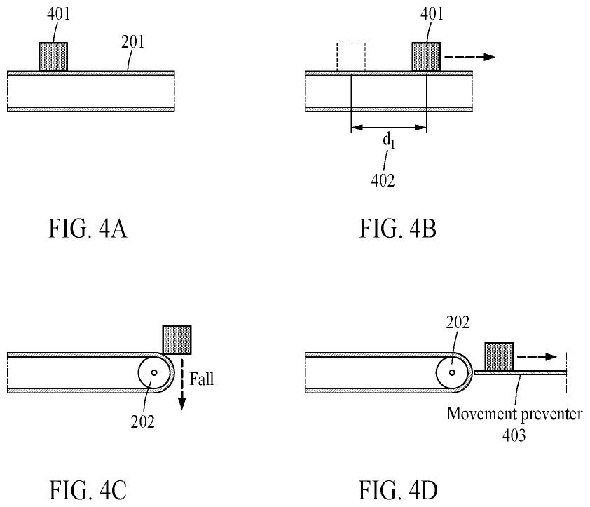

FIGS. 4A to 4D are diagrams illustrating an example in which a foreign object falls through a foreign object removal screen according to an example embodiment.

Referring to FIG. 4A, a foreign object 401 may move in a direction of a vertical or horizontal movement of the foreign object removal screen 201 by a rotating body.

Referring to FIG. 4B, the foreign object 401 may be moved by a predetermined interval 402 in a direction of the foreign object removal screen 201. The foreign object 401 may move from a first position of the foreign object 401 to a second position in a state in which a position on the foreign object removal screen 201 is fixed. Here, the foreign object removal screen 201 may change a position of the foreign object 401 from one point to another point.

Referring to FIG. 4C, when the foreign object removal screen 201 reaches one end of both ends in which rotating bodies are disposed, the foreign object 401 may fall to an outer region of the one end.

Referring to FIG. 4D, when the foreign object removal screen 201 reaches one end of both ends in which rotating bodies are disposed, the foreign object 401 may fall to a movement preventer disposed in the one end.

As a result, the foreign object removal screen 201 as a foreign object remover for mechanically removing a foreign object attached to a surface may be attached to a transmitter, and may induce a foreign object to escape from a charging area of the transmitter.

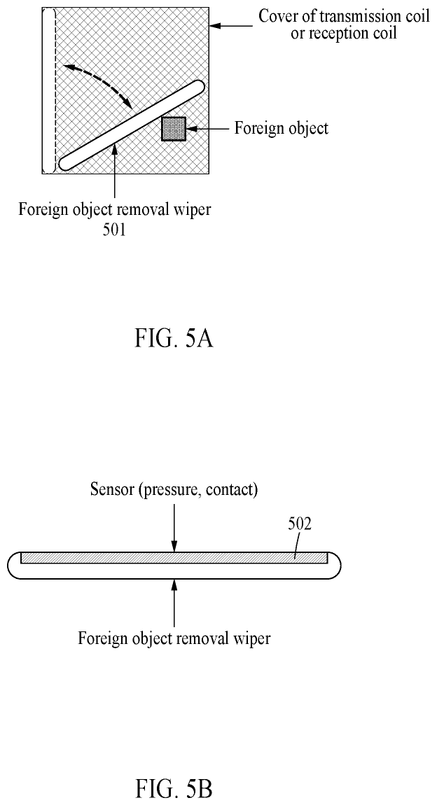

FIGS. 5A and 5B are diagrams illustrating a structure of a wireless charging system for removing a foreign object using a foreign object removal wiper according to an example embodiment.

Referring to FIGS. 5A and 5B, a foreign object 503 attached to a surface of a cover 502 may be removed using a foreign object removal wiper 501. To this end, a transmitter according to an example embodiment may include a transmission coil (not shown), the cover 502, the foreign object removal wiper 501, and a rotating body (not shown). Since wireless charging using a magnetic field is performed sensitively to a metal and insensitively to a nonmetal (for example, a dielectric), all the above-described components of the transmitter may need to be formed of nonmetals.

Referring to FIG. 5A, the foreign object removal wiper 501 for removing a foreign object may be attached to one side of the cover 502 of the transmitter. To protect a surface of the transmission coil, the cover 502 may be implemented to cover an outer surface of the transmission coil, that is, the outside.

The foreign object removal wiper 501 may be disposed on one surface of the cover 502, that is, one end of the cover 502, to remove the foreign object 503 attached to the surface of the cover 502. The foreign object removal wiper 501 may include a pressure sensor 502 on one surface of the foreign object removal wiper 501 as shown in FIG. 5B. The pressure sensor 502 may determine a presence or absence of the foreign object 503 attached to the surface of the cover 502 while moving on the surface of the cover 502. The pressure sensor 502 may be replaced by a contact sensor according to circumstances, and may transfer the presence or absence of the foreign object 503 to the wireless charging system.

One end of the foreign object removal wiper 501 may include a rotating body configured to control a rotation of the foreign object removal wiper 501. When a foreign object is detected in the charging area, the rotating body may perform a rotational motion such that the foreign object removal wiper 501 may move at a constant speed at a predetermined angle in a specific direction.

The foreign object removal wiper 501 may remove the foreign object 503 attached to the surface of the cover 502 while moving on the surface of the cover 502 by the rotating body. In other words, the foreign object removal wiper 501 may be moved in a specific direction by the rotating body. In addition, the foreign object 503 may be removed while being pushed from a first position to a second position on the surface of the cover 502. Here, the first position may be an initial position at which the foreign object 503 is attached to the surface of the cover 502, and the second position may be a position in which the foreign object 503 is to be moved by the foreign object removal wiper 501.

The transmitter for wireless charging including the transmission coil may remove a foreign object in the charging area of the transmitter using the foreign object removal wiper 501. For example, the transmitter may remove a foreign object attached to the surface of the cover 502 while moving the foreign object to one side using the foreign object removal wiper 501.

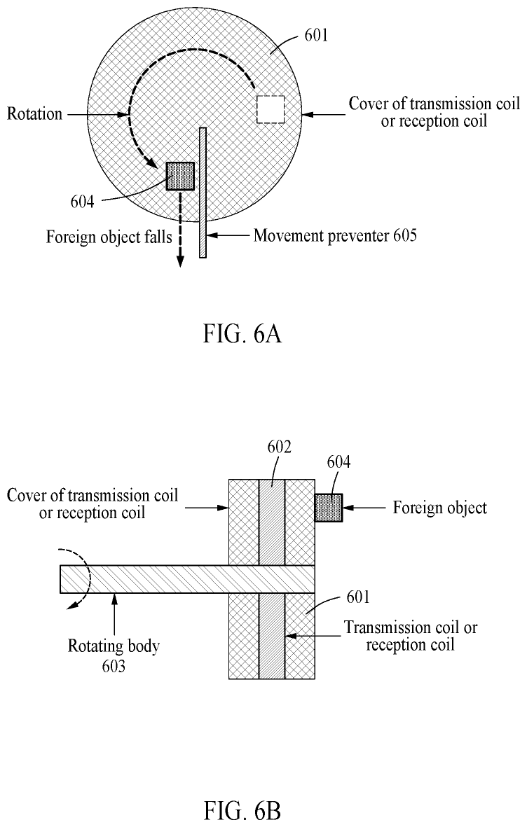

FIGS. 6A and 6B are diagrams illustrating a structure of a wireless charging system for removing a foreign object using a rotating body according to an example embodiment.

Referring to FIGS. 6A and 6B, a foreign object 604 attached to a surface of a cover 601 may be removed using a rotating body 603 of a transmitter. To this end, the transmitter may include a transmission coil 602, the cover 601, the rotating body 603, and a movement preventer 605. Since wireless charging using a magnetic field is performed sensitively to a metal and insensitively to a nonmetal (for example, a dielectric), all the above-described components of the transmitter may need to be formed of nonmetals.

The cover 601 of the transmitter may be rotated directly by the rotation body 603. The foreign object 604 may be removed by the movement preventer 605 spaced apart from the surface of the cover 601 and fixed, while a position is changed according to a rotational motion of the cover 601.

Here, a rear surface of the cover 601 may be connected to the rotating body 603, and the rotating body 603 may be shaped to penetrate a central region of the cover 601 and the transmission coil 602, and may allow the cover 601 to rotate at a constant speed along a central axis.

The cover 601 may rotate as the rotating body 603 connected to the rear surface of the cover 601 rotates, and a foreign object attached to the cover 601 may be rotated and moved by the cover 601 and may fall by gravity, or may be caught in the moving preventer 605 to be removed. Here, the movement preventer 605 may be fixed to an end of the rotating body 603, and may be spaced apart from the cover 601 by a predetermined height.

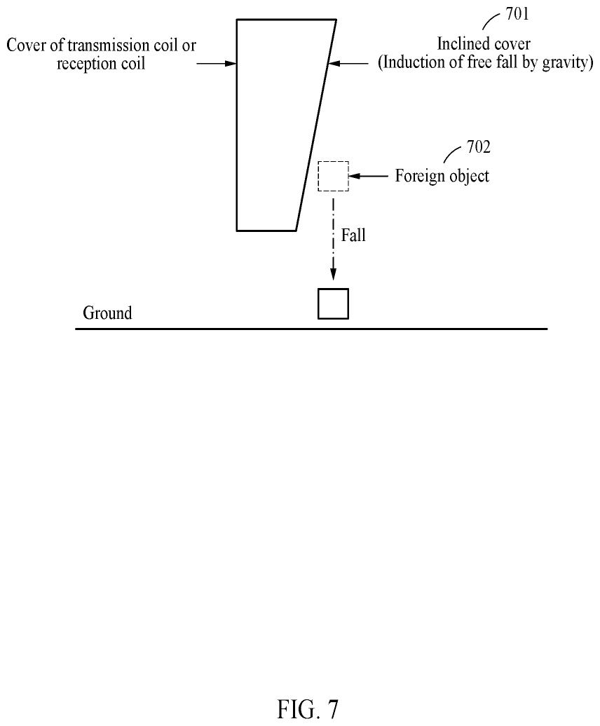

FIG. 7 is a diagram illustrating a structure of a wireless charging system for removing a foreign object using an inclined cover according to an example embodiment.

Referring to FIG. 7, a foreign object attached to a surface may be removed using an inclined cover 701. For example, the inclined cover 701 may be implemented to cover an outer surface, that is, the outside, of a transmission coil, to protect a surface of the transmission coil. A lower side of the inclined cover 701 may be implemented in a form of a plane, and an upper side of the inclined cover 701 may be implemented to be inclined. In other words, the upper side of the inclined cover 701 may be formed as a slope or an oblique line in which a structure surface is inclined with respect to a horizontal plane that is the lower side of the inclined cover 701. Here, an angle of inclination of the inclined cover 701 may be formed to be 30 degrees or more, and a cover surface of the inclined cover 701 may be formed of a smooth material.

According to an example embodiment, through the inclined cover 701, a free fall may be induced so that all foreign objects may slide down by gravity. Thus, according to an example embodiment, it may be possible to fundamentally block a possibility of a presence of a foreign object having metallic properties in a transmitter.

As a result, according to an example embodiment, when wireless charging is performed, a foreign object may slide down through an inclined surface according to the angle of inclination of the inclined cover 701 even though the foreign object is attached to the surface. Thus, the foreign object attached to the surface may fall to the ground without a need to perform a separate operation, and may be removed.

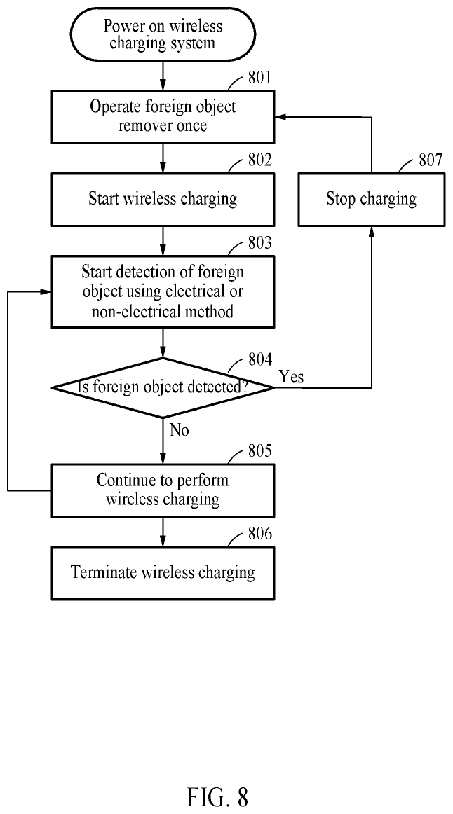

FIG. 8 is a flowchart illustrating a wireless charging process for removing a foreign object according to an example embodiment.

According to an example embodiment, the wireless charging process of FIG. 8 may be provided based on a monitoring sequence for removing a foreign object that is attachable to a charging area of a transmitter. Referring to the wireless charging process of FIG. 8, an event of detecting a foreign object only for a first time may occur according to an operation of a wireless charging system. In other words, when an event in which a foreign object is detected occurs or when wireless charging is started, a foreign object remover may operate once.

In operation 801, when the wireless charging system is powered on, a mechanical component (hereinafter, referred to as a “foreign object remover”) attached to the transmitter may be operated once. The foreign object remover may be operated regardless of a presence or absence of a foreign object, to clean a surface of the transmitter.

In operation 802, the transmitter may detect an object present in the charging area of the transmitter, and may start wireless charging with the detected object. Here, since the surface of the transmitter is cleaned in operation 801, wireless charging with the object detected in the charging area may be started.

In operation 803, the transmitter may monitor a presence or absence of a foreign object that is attachable to the charging area of the transmitter during the wireless charging. A voltage, a current, an impedance or a resonant frequency may be used to monitor a presence or absence of a foreign object in the charging area by an occurrence of abnormality in a transceiver circuit due to a foreign object, by receiving a sensing signal from a connected wireless charging system, or by receiving a foreign object sensing signal obtained by a non-electrical method such as image information from a system.

In operation 804, whether a foreign object is present may be determined by detecting an occurrence of abnormality in the transceiver circuit, or by receiving a sensing signal from the wireless charging system.

In operation 805, the transmitter may maintain wireless charging with an object when there is no foreign object.

When no object is detected in the charging area of the transmitter, when charging of a receiver is completed, or when the receiver receives a separate charging stop signal from an external system, the transmitter may terminate the wireless charging in operation 806.

When a foreign object is present, the transmitter may stop the wireless charging in operation 807, and may remove the foreign object attached to the charging area of the transmitter in operation 801.

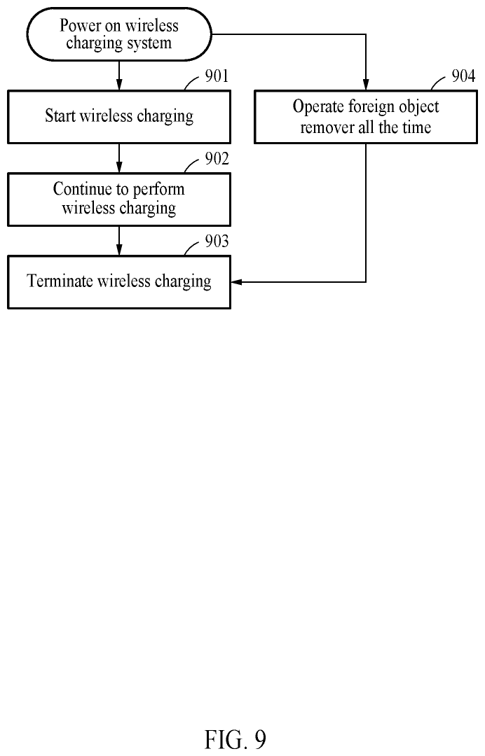

FIG. 9 is a flowchart illustrating another example of a wireless charging process for removing a foreign object according to an example embodiment.

According to an example embodiment, the wireless charging process of FIG. 9 may be provided based on a monitoring sequence to remove a foreign object that is attachable to a charging area of a transmitter. Referring to the wireless charging process of FIG. 9, an event of detecting a foreign object all the time may occur according to an operation of a wireless charging system.

When the wireless charging system is powered on in operation 901, the transmitter may detect an object present in the charging area of the transmitter, and start wireless charging with the detected object.

Here, simultaneously with starting the wireless charging, the transmitter may operate a foreign object remover attached to the transmitter at regular intervals all the time in operation 904. Here, the foreign object remover may be operated to clean a surface of the transmitter regardless of a presence or absence of a foreign object, and accordingly a separate function for an electrical foreign object detection may be unnecessary in the wireless charging system.

In operation 902, the transmitter may maintain the wireless charging with the object present in the charging area.

When no object is detected within the charging area of the transmitter, when charging of a receiver is completed, or when the receiver receives a separate charging stop signal from an external system, the transmitter may terminate the wireless charging in operation 903.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A transmitter for wireless charging, the transmitter comprising:
a transmission coil;
a cover configured to protect a surface of the transmission coil;
a foreign object removal screen disposed on a surface of the cover to remove a foreign object; and
rotating bodies connected to the foreign object removal screen and disposed at both ends of the cover.

2. The transmitter of claim 1, wherein the foreign object removal screen is disposed in a charging area of the transmitter for wireless charging that includes the transmission coil, and is configured to detect a foreign object to be removed among objects detected in the charging area.

3. The transmitter of claim 1, wherein the rotating bodies are configured to perform a rotational motion to continuously move a foreign object detected in a charging area of the foreign object removal screen.

4. The transmitter of claim 3, wherein the foreign object removal screen encloses an upper surface and a lower end of the cover that protects the surface of the transmission coil, and moves according to the rotational motion of the rotating bodies.

5. The transmitter of claim 4, wherein the foreign object is pushed from a first position sensed by the foreign object removal screen to a second position according to a vertical movement or a horizontal movement of the foreign object removal screen.

6. The transmitter of claim 4, wherein when the foreign object removal screen reaches one end of both ends in which the rotating bodies are disposed, the foreign object falls to an outer region of the one end.

7. The transmitter of claim 4, wherein when the foreign object removal screen reaches one end of both ends in which the rotating bodies are disposed, the foreign object falls to a movement preventer disposed at the one end.

8. A transmitter for wireless charging, the transmitter comprising:
a transmission coil;
a cover configured to protect a surface of the transmission coil;
a foreign object removal wiper disposed on a surface of the cover to remove a foreign object; and
a rotating body configured to control rotation of the foreign object removal wiper.

9. The transmitter of claim 8, wherein the foreign object removal wiper is disposed at one end of the cover to detect a foreign object to be removed among objects detected in a charging area of the transmitter for wireless charging that includes the transmission coil.

10. The transmitter of claim 9, wherein when a foreign object is detected in the charging area, the rotating body performs a rotational motion such that the foreign object removal wiper moves at a predetermined angle in a specific direction.

11. The transmitter of claim 10, wherein:
the foreign object removal wiper comprises a pressure sensor on one surface of the foreign object removal wiper, and
the pressure sensor is configured to determine a presence or absence of a foreign object attached to the surface while moving on a surface of the cover.

12. The transmitter of claim 10, wherein the foreign object is removed while being pushed from a first position sensed by the foreign object removal wiper to a second position in a specific direction of the foreign object removal wiper.

13. A transmitter for wireless charging, the transmitter comprising:
a transmission coil;
a cover configured to protect a surface of the transmission coil; and
a rotating body configured to allow the cover to rotate to remove a foreign object attached to a surface of the cover.

14. The transmitter of claim 13, wherein the rotating body is shaped to penetrate a central region of the cover and the transmission coil and is configured to allow the cover to rotate at a constant speed along a central axis.

15. The transmitter of claim 13, wherein:
in the rotating body, a movement preventer is fixed to an end of the rotating body,
the movement preventer is spaced apart from the cover by a predetermined height, and
the foreign object is caught by the movement preventer while being rotated by the rotating body, to fall to an outside of the cover.
